(19) United States
(12) Patent Application Publication
(10) Pub. No.: US 2017/0194901 A1
(43) Pub. Date: Jul. 6, 2017

(54) Solar Cell Module and Method for Producing a Solar Cell Module

(71) Applicant: Hanwha Q CELLS GmbH, Bitterfeld-Wolfen (DE)

(72) Inventors: Lothar Seliger, Tirpersdorf (DE); Uwe Weigelt, Lutherstadt Wittenberg (DE); Markus Traeger, Leipzig (DE)

(21) Appl. No.: 15/389,687

(22) Filed: Dec. 23, 2016

(30) Foreign Application Priority Data
Jan. 4, 2016 (DE) 10 2016 100 053.1

(51) Int. Cl. H02S 40/36; H02S 40/34

(52) U.S. Cl. CPC H02S 40/36; H02S 40/34

(57) ABSTRACT

A solar cell module (100) comprises a first terminal (101) and a second terminal (102), a plurality of solar cells (110) and a switch (120). The solar cells (110) can be electrically connected to one another between the first terminal (101) and the second terminal (102) in order to generate a voltage between the first terminal (101) and the second terminal (102) in normal operation. The switch (120) electrically connects the first terminal (101) and the second terminal (102) to one another in a default setting or isolates the plurality of solar cells (110) from the first or from the second terminal (101, 102) and can be controlled in such a way that, when a valid control signal is present, the first terminal (101) is electrically isolated from the second terminal (102) or the plurality of solar cells (110) are connected to the first and the second terminal (101, 102).

The present invention relates to a solar cell module (photovoltaic module) and a method for producing a solar cell module and in particular to a plugless module having an intelligent and switchable connecting socket.

### BACKGROUND

At the present time nearly all solar cell modules are equipped with plugs or special plug devices. This is intended to make it impossible to accidentally touch the electrical connecting wires, on which considerable voltages (for example up to 1000 V) can lie when exposed to light, during assembly of the solar cell modules or the transportation thereof.

FIG. 6 shows by way of example the assembly of presently used solar cell modules. Four solar cell modules 600a, 600b, 600c, 600d, each having two electrical terminals 601a, 602a, 601b, 602b, . . . on which in each case a socket (or plug) 621a, 622a, 621b, 622b, . . . is formed, are shown. The first solar cell module 600a has a first terminal 601a with a plug 621a and a second terminal 602a with a socket 622a. In the same way, the second solar cell module 600b, the third solar cell module 600c and the fourth solar cell module 600d are in each case formed with a plug and socket 621b, 621c, 622b, 622c, . . . By way of example, the fourth solar cell module 600d is shown from the rear thereof, wherein the connecting socket 640, which each of the shown solar cell modules 600a, 600b, 600c, 600d has, can be seen.

The four conventional solar modules shown are, for example, connected such that the first and fourth solar cell module 600a, 600d and the second and third solar cell module 600b, 600c are in each case connected in series. In addition, the serially connected solar cell modules (strings) 600a, 600d and 600b, 600c are connected in parallel with one another by means of Y-connectors 604, 605 and are connected to an inverter 650. This corresponds to a present-day configuration of a solar panel, wherein any number (corresponding to the parameters of the inverter 650) of modules can be connected serially and strings in parallel. The conventional inverter is designed to convert the direct current generated from the solar modules into network-compliant alternating current.

In the example shown, the second solar cell module 600b and the third solar cell module 600c are connected serially to one another in that the socket 622b of the second solar cell module 600b is connected to the plug 621c of the third solar cell module 600c. In addition, the plug 621b of the second solar cell module 600b is connected to a terminal of the inverter 650, and the socket 622c of the third solar cell module 600c is connected to a further terminal of the inverter 650.

In addition, in the example shown, the socket 622a of the first solar module 600a is connected by means of a separate lead 603 to a first Y-plug 604, which makes an electrical connection to the socket 622c of the third solar cell module 600c. The plug 621a of the first solar cell module 600a is connected to the fourth solar cell module 600d, which in turn is connected by means of a further separate lead 606 to a second Y-plug 605, which, for its part, is connected to the plug 621b of the second solar cell module 600b.

The inverter 650 therefore receives the voltage generated in the four solar cell modules 600a, 600b, 600c, 600d due to exposure to light, wherein current conductors 651 divert the generated current and the inverter 650 optionally carries out a transformation.

The solar cell modules 600a, 600b, 600c, 600d shown can be installed while being exposed to light as the voltage generated by exposure to light is electrically insulated by the plugs 621 and sockets 622 and it is impossible to accidentally touch the corresponding connecting wires. If these plugs/sockets 621, 622 were not provided (see FIG. 7), there would be a risk that a voltage generated by an incidence of light on the solar cell modules boo could present a considerable hazard at the uninsulated ends of the connecting cables. With appropriate exposure to light, voltages up to 1000 V or more can lie on the current conductors 601, 602.

As these high voltages represent a considerable risk of accident, applicable regulations for working with live parts forbid the use of plugless modules. In the past, although there were also solar cell modules which were supplied without cables and plugs, these had to be installed in the dark or mounted in an insulated manner.

FIG. 6 shows that the plurality of plugs and separate leads already represents considerable additional outlay. However, the known plugless variant also means additional effort due to the darkness when carrying out the installation.

There is therefore a demand for solar cell modules which do not require the plugs or plug connectors, which, however, on the other hand, can be produced cheaply and nevertheless provide a high degree of safety.

### SUMMARY

The above object is achieved by a solar cell module according to claim 1 and a method according to claim 16. The dependent claims relate to advantageous developments of the subject matter of claim 1.

The present invention relates to a solar cell module comprising a first terminal and a second terminal, a plurality of solar cells and a switch. The solar cells are or can be electrically connected to one another between the first terminal and the second terminal in order to generate a voltage between the first terminal and the second terminal in normal operation (current generation mode). In a default setting (i.e. not in normal operation) the switch electrically connects the first terminal and the second terminal to one another. The switch can also be controlled in such a way that, when a valid control signal is present, the first terminal is electrically disconnected from the second terminal. In a further embodiment, the switch disconnects the plurality of solar cells from the first and/or the second terminal and can be controlled in such a way that, when the valid control signal is present, the plurality of solar cells is connected to the first and the second terminal.

Some or all solar cells can be serially connected to one another or also partially electrically connected in parallel. In doing so, normal operation relates to the generation of current on exposure to light so that the plurality of solar cells remains short-circuited (or isolated) until they are electrically isolated (or connected) by activating the normal mode and a voltage can be generated between the first and second terminal. In the default setting, the solar cells are short-circuited (or decoupled) by connecting the first and second terminal. For example, the solar cell module is in the default setting after production or during transportation, wherein the default setting can be assumed whenever no control signal is applied.

In particular, in exemplary embodiments it is possible for the first terminal and the second terminal to be plugless, so that the electrical connecting wires connected to the first and second terminal can be exposed, i.e. have no insulation. As an option, however, it is also possible for the plugs to be still provided as designed in conventional embodiments (see FIG. 6). The invention shall not be restricted to the plugless case.

The valid control signal can, for example, have a predetermined voltage characteristic which differs from zero so that a voltage-free case is not a valid control signal. For example, in further exemplary embodiments, the valid control signal is coded in the form of a predetermined pulse sequence. As an option, however, the valid control signal can also be provided in the form of an encrypted signal. The switch can be designed to decrypt the encrypted signal and to automatically electrically isolate the first terminal from the second terminal in response to a recognition of the valid control signal.

In further exemplary embodiments, the valid control signal is specifically for the solar cell module or for a plurality of solar cell modules so that one or more solar cell modules can be selectively activated by transmitting the valid control signal.

In further exemplary embodiments, the switch includes an optional control terminal, wherein, for example, the control terminal is only formed internally in the connecting socket and can be coupled to a control unit (driver device) and provides the control unit with the valid control signal. In addition, in exemplary embodiments, the solar cell modules are connected to an inverter which is designed to convert the direct current generated from the solar modules into network-compliant alternating current. The inverter can be designed in the same way as the conventional inverter from FIG. 6. The “driver device” for the switch (switch boxes) provides the valid control signal(s), for example, and can be connected separately to the inputs of the inverter; however it can also be integrated into the inverter depending on the design.

In further exemplary embodiments, the switch includes a network interface to a wireless network, wherein the network interface can couple to the control terminal, for example, and is designed to receive the valid control signal from the wireless network. As an example, the wireless network can include a WLAN network, Bluetooth connection(s) or a mobile radio network or be such a network.

In further exemplary embodiments, the switch is designed to retain a switching state as long as the valid control signal is present and, in the absence of the control signal, automatically connect the first terminal to the second terminal (i.e. the solar cell module is short-circuited).

In further exemplary embodiments, the switch is designed to retain a switching state (even without valid control signal) so that a single transmission of the valid control signal is sufficient to permanently isolate the first terminal from the second terminal. An advantage of this embodiment is that the control signal does not have to be continuously transmitted and a single transmission is sufficient to activate the solar cell module. At the same time, however, it can be provided that the first and second terminal are short-circuited again for safety reasons when the solar cell module is switched off (for example due to a disconnection of the control wire or the connecting wires). As an option, in this embodiment, it is of advantage if the solar cell module is designed with plugs and not plugless as in other embodiments.

In further exemplary embodiments, the switch is further designed to electrically connect the first terminal to the second terminal when a further control signal is present. An advantage of this embodiment is that one solar cell module or a plurality of solar cell modules can be selectively switched off, wherein, on switching off, the first and the second terminal are short-circuited together (i.e. no voltage is present between the first and the second terminal). Here, the further control signal can differ from the valid control signal.

In further exemplary embodiments, the solar cell module together with the switch forms a monolithic unit. An advantage of this embodiment is that the switch cannot be removed or bridged by a user, thus providing a high degree of safety. Exemplary embodiments of the present invention can therefore not be circumvented by simple tampering. Here, the term “monolithic unit” is also to be understood to mean that the switch can only be disconnected by (partially) destroying the solar cell module, i.e. the solar cells and the switch form integral components of the solar cell module.

In further exemplary embodiments, the first terminal and the second terminal are integrated in the switch and are designed to electrically connect to and fix at least one connecting cable by inserting it. For example, in further exemplary embodiments, the first terminal and the second terminal comprises a push-in clamp connection which allows a connecting cable to be pushed in in one direction and blocks it in an opposing direction.

The present invention also relates to a method for producing a solar cell module. The method includes the following steps: providing solar cells which are electrically connected to one another, connecting the solar cells to a first terminal and a second terminal, forming a short circuit between the first terminal and the second terminal or a disconnection of the plurality of solar cells from the first or from the second terminal, and open the short circuit or closing the disconnection of the plurality of solar cells from the first or from the second terminal in response to the presence of a valid control signal.

The exemplary embodiments mentioned achieve the above-mentioned technical object in that the solar cell module includes a switch or a connecting socket with appropriate electronics. For example, in every connecting socket of the solar modules is an intelligent switch unit, which, depending on the design, is able to either short-circuit the module (no voltage at the terminals) or to isolate a terminal (isolation of the module at a terminal and therefore also voltage-free). Integrating the electronics in the appropriate switch enables the safety requirements described above to be fulfilled even for plugless cables. To this end, the electronics short-circuit the two connecting wires at which the voltage is generated due to exposure to light (i.e. the first and second terminal) in the normal case (default setting). The electronics can also disconnect the solar cells from at least one of the terminals. The connecting wires are only electrically disconnected from one another or the current path through the solar cells is only closed by means of an activation signal (valid control signal). A voltage at the connecting wires can therefore only be generated when this predetermined signal is present.

As the valid control signal and the driver device can be extensively chosen at will, according to exemplary embodiments it is also possible to quite selectively assign certain control signals, which are recognized by the module (solar cell module), to certain connecting sockets or control modules connected thereto. In this way, the appropriate solar cell module can only be activated by recognizing the control signal (or confirming that the control signal is valid).

A considerably higher added value with at the same time improved safety behavior is achieved thereby. The increased costs associated with the switch and the corresponding electronics can be compensated to a great extent by the omission of the plugs and/or connecting cables. If, in addition, encrypted pulse sequences are used as valid control signals on the DC side (direct voltage side) of the photovoltaic modules, in exemplary embodiments, the modules can be specifically initiated and enabled in the socket. In the event of a failure of the pulse sequence and/or a faulty control device (control unit), the module automatically short-circuits itself and therefore presents no safety risk. The omission of the plugs therefore offers an enormous cost saving potential. However, it must be pointed out that the present invention does not necessarily relate to plugless solar cell modules.

### BRIEF DESCRIPTION OF THE FIGURES

The exemplary embodiments of the present invention are better understood from the following detailed description and the attached drawings, which, however, should not be understood to mean that they limit the disclosure to the specific exemplary embodiments but are merely used for explanation and understanding.

FIG. 1 shows a solar cell module according to an exemplary embodiment of the present invention.

FIG. 2 shows the solar cell module with a plurality of solar cells which are electrically connected to one another with two connecting wires.

FIG. 3 shows an exemplary embodiment of push-in clamp connections at the connecting socket.

FIG. 4A shows an exemplary embodiment of a circuit of four solar cell modules.

FIG. 4B, 4C show an embodiment of the solar cell module with connection sockets.

FIG. 5 shows a flow diagram for a method for producing a solar cell module according to an exemplary embodiment.

FIG. 6 shows a circuit of conventional solar cell modules with plugs.

FIG. 7 illustrates the safety risk with conventional solar cell modules and non-insulated terminals.

### DETAILED DESCRIPTION

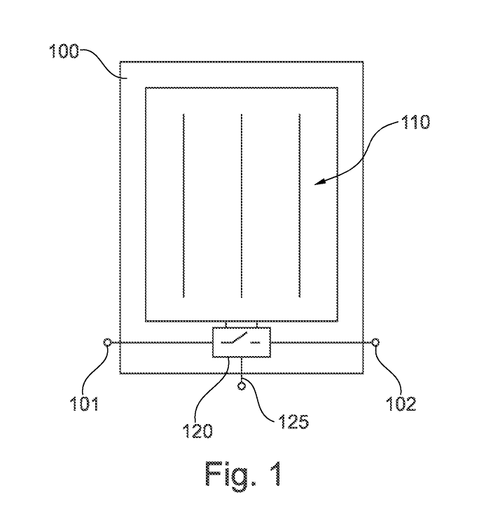

FIG. 1 shows a solar cell module 100 according to an exemplary embodiment of the present invention. The solar cell module 100 comprises a first terminal 101 and a second terminal 102, a plurality of solar cells 110 and a switch 120 (switch box or isolator). The solar cells no are electrically connected to one another between the first terminal 101 and the second terminal 102 in order to generate a voltage between the first terminal 101 and the second terminal 102 in normal operation. In a default setting (i.e. not in normal operation) the switch/isolator 120 electrically connects the first terminal 101 to the second terminal 102. The switch/isolator 120 includes a control terminal 125, for example, for receiving control signals. When a valid control signal is present, the switch 120 disconnects the first terminal 101 from the second terminal 102. It is also possible for the switch 120 to isolate the plurality of solar cells 110 from the first terminal 101 and/or from the second terminal 102 in a default setting and to connect them in response to the valid control signal.

In neither case can a voltage be generated between the first and second terminals 101, 102 due to exposure to light. In the first embodiment, the short circuit prevents a voltage and, in the second embodiment, there is no closed current path through the solar cells no to the first and to the second terminal 101, 102.

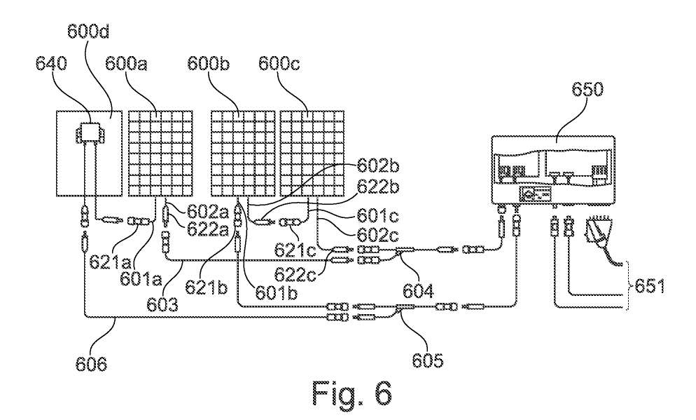

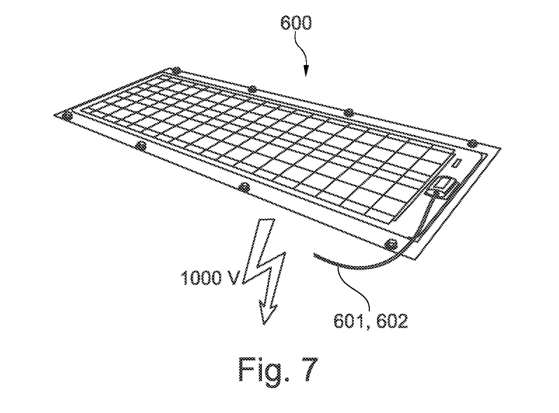

According to exemplary embodiments, the connecting plugs 621, 622 from FIG. 6 can be completely omitted when producing the module and the installation can be carried out without connecting plugs. Faulty plug connections (for example due to penetrating moisture or other malfunctions) can therefore be excluded. Insulation problems, such as are often caused by plugs, can likewise be prevented thereby. In spite of this, a high degree of safety is guaranteed by the switch 120 (i.e. by the included electronics), as the switch 120 only enables the terminals 101, 102 to generate current when the valid control signal is present.

In particular, the switch/isolator 120 can be designed as or in a connecting socket and not only have a passive switch component. Rather, the switch 120 can itself include electronics which can be programmed accordingly to carry out the switch functions mentioned above.

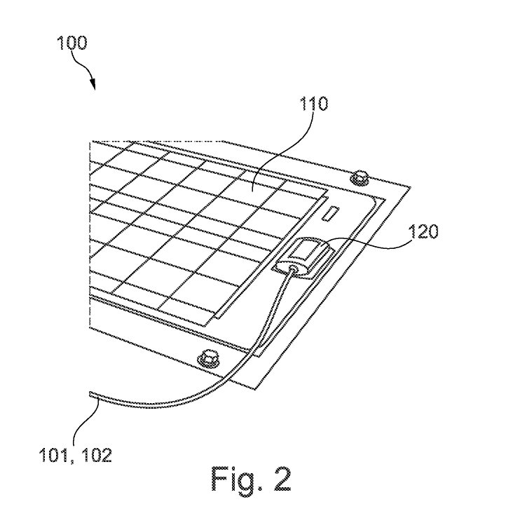

FIG. 2 shows the solar cell module 100 with a plurality of solar cells no which are electrically connected to one another. The individual solar cells 110 can be connected to one another serially as well as (partially) in parallel, wherein the voltage between the first terminal 101 and the second terminal 102 is generated when the plurality of solar cells 110 is exposed to light. According to the exemplary embodiment shown, the switch 120 is securely fixed to the solar cell module 100 (e.g. an integrated component) so that the electrical current paths from the solar cells no are fed directly to the switch 120 (e.g. without further intermediate connection).

The switch 120 allows a circuit of the solar cell module 100 in an idle state (default setting) and an operating state. In the idle state, the first terminal 101 and the second terminal 102 are electrically connected to one another (short-circuited or isolated) and this state can be assumed whenever no valid control signal is present at the switch 120. The valid control signal can be transmitted to the switch 120 via the normal PV cable (photovoltaic cable). For example, voltage pulses can be added on the direct voltage cable of the solar cell modules (which are connected at terminals 101, 102). These control signals can be received and evaluated by means of the connecting socket with the switch 120. The switch 120 can also be designed to receive and evaluate an additional alternating voltage signal which is present at the first and/or second terminal 101, 102.

As an option, this can also take place via a wireless connection which, for example, couples to the control terminal 125. For example, only when the switch 120 receives the valid control signal can the switch 120 electrically isolate the first terminal 101 from the second terminal 102 and incident light can generate a corresponding voltage between the first terminal 101 and the second terminal 102. This is the operating state.

If, for some reason, the valid control signal is no longer present at the switch 120, the switch 120 can immediately short-circuit/isolate the first terminal 101 and the second terminal 102 so that no danger emanates from the solar cell module 100. For example, the switch 120 can be designed such that no additional energy is required for this automatic shutdown. As an example, in the event of damage to electrical wiring or an interruption of the control wire, the solar cell module 100 can thus shut itself down automatically. This provides a high degree of safety and extends anti-theft protection.

In further exemplary embodiments, the solar cell module 100 can be selectively switched off by means of a further control signal which is transmitted to the switch 120. In this way, for example, it is possible for a plurality of solar cell modules to be activated by means of a single valid control signal while individual solar cell modules can be switched off by means of specific further control signals. For example, a specific deactivation signal for the module can be assigned to each solar cell module. The same is likewise possible for activation. Thus, for example, a general activation signal can be defined with which a plurality of solar cell modules (or all) can be activated simultaneously while specific activation signals (or deactivation signals) can be used selectively for activating (or deactivating) individual or some solar cell modules.

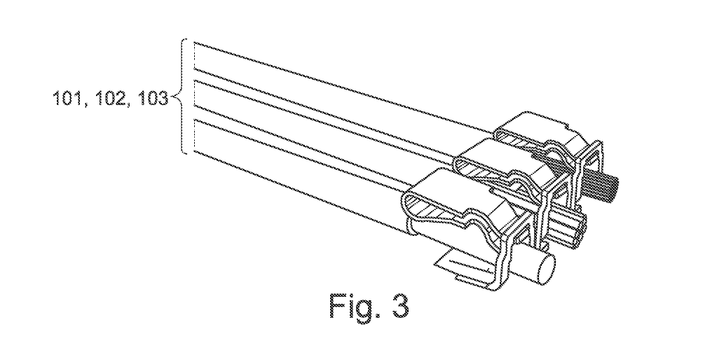

FIG. 3 shows an exemplary embodiment of push-in clamp connections. The connecting cables shown can, for example, be used for the first or second terminal 101, 102, wherein different embodiments for the connecting cables 101, 102, 103 are shown (as monolithic cable or as more or less large cable bundle). The push-in clamp connections enable a connecting cable to be inserted in one direction (in FIG. 3 from left to right), while movement in the opposite direction is blocked. For this purpose for example, the terminal clamp connections have a leaf-spring-like structure with an edge which prevents a movement of the cable in the blocking direction (due to clamping) but allows insertion in the pushing-in direction by bending the leaf spring structure. The required properties of the photovoltaic connecting socket are retained by a simple strain relief including a seal and/or potting.

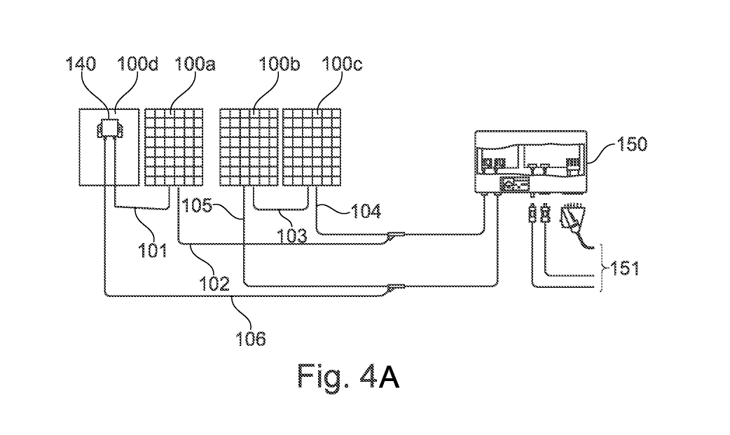

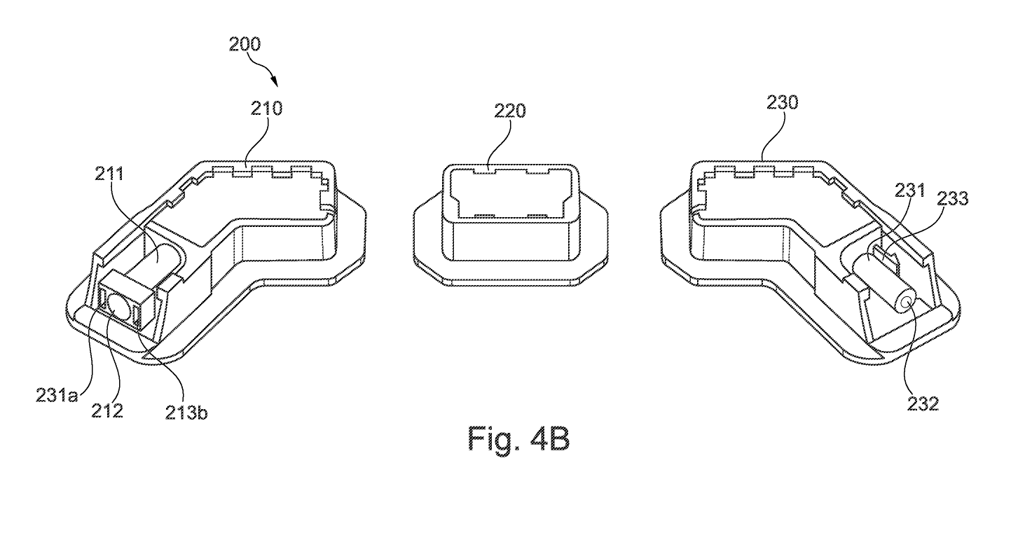

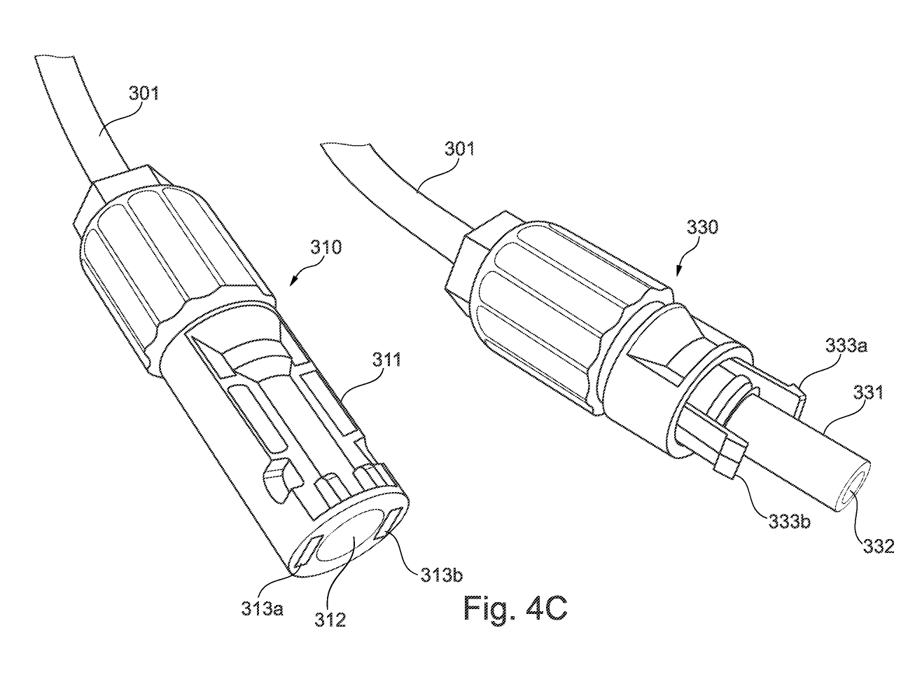

FIG. 4A shows an embodiment of a circuit of four solar cell modules 100a, 100b, 100c and 100 d, which couple to an inverter with control device 150. The inverter 150 can control the solar cell modules 100a, 100b, 100c and 100d and also dissipate the generated current. The current can be dissipated via current conductors 151 for example. Control of the control device can be carried out, for example, by generating or providing the various previously mentioned control signals. The control device can be part of the inverter 150 or couple to one or more inputs/outputs of the inverter 150 in order to transmit the control signals via the connecting wires shown or wirelessly to the solar cell modules.

As in FIG. 6, two solar modules 100a, 100b, 100c, 100d, in each case connected in series and then in parallel, are again shown by way of example, wherein the fourth solar module 100d, for example, is shown from the rear thereof in order to make the connecting socket 140 with the switch 120 (not shown) visible. In the example shown, the second solar cell module 100b and the third solar cell module 100c are connected serially with the inverter 150. The second solar cell module 100b is therefore connected via a third connecting wire 103 to the third solar cell module 100c, while the third solar cell module couples directly to the control unit 150 via a fourth connecting wire 104. In addition, the second solar cell module 100b is likewise connected to the control unit 150 via a fifth connecting wire 105.

The first solar cell module 100a is serially connected to the fourth solar cell module 100d in a similar way. The serially connected solar cell modules (i.e. the first and fourth solar cell module 100a, 100d) are connected in parallel with the serially connected second and third solar cell module 100b, 100c. A first connecting wire 101 is fed between the first solar cell module 100a and the fourth solar cell module 100d for this purpose. A second connecting wire 102 connects the first solar cell module 100a to the inverter 150 and a sixth connecting wire 106 connects the fourth solar cell module 100d to the inverter 150. The inverter 150 has mains connecting wires 151 (with optional control wires) which are used, for example, to dissipate the current generated by the solar cell modules 100a, 100b, 100c, 100d. The inverter 150 can carry out a current conversion (e.g. transform the voltage or generate alternating current). The inverter 150 can therefore electrically isolate the DC side (solar module side) from the AC side (side where alternating voltage is present) (inverter with transformer).

The exemplary embodiment therefore only differs from the conventional circuit, as can be seen in FIG. 6, in that only one connecting cable per module is needed in each case to connect to the next and without a plug.

However, the present invention shall not be limited to plugless modules but shall also cover solar modules comprising connection sockets for connecting multiple solar modules using connection plugs.

FIG. 4B depicts an embodiment for connection sockets arranged on the rear side (opposite to the irradiation side) of a solar module. The connection socket 200 comprises a first part 210, a second part 220, and a third part 230. The first part 210 and the third part 230 are, for example, arranged on opposite sides of the second part 220. The first part 210 comprises a first terminal 211 and the third part 230 comprises a second terminal 231. The first terminal 211 comprises, for example, a recess 212 for inserting a male plug. Moreover, the first terminal 211 comprises a first opening 213a and a second opening 213b being configured to allow protrusions to enter the openings 213a, 213b and to provide a latch fixation of the inserted male connector. The second terminal 231 is an example for a male connector with a hole 232 for inserting a contact line. The second connector 231 further comprises two protrusions 233 (only one of which is shown) which is configured to provide a latch locking mechanism to fix a connector to the second terminal 231. The second part 220 arranged between the first part 210 and the third part 230 covers, for example, a bypass diode arranged underneath the second part 220 which is formed as a housing.

FIG. 4C depicts an exemplary connection line 301 with a first terminal 310 on one side and a second terminal 330 on another side. The first terminal 310 again comprises a central recess 312 for inserting a male plug. The first terminal 310 further comprises a first opening 313a and a second opening 313b for inserting protrusions to provide a latching mechanism to fix the line 301, for example, to the second terminal 231 depicted in FIG. 4B. The second terminal 330 of the line 301 comprises again a terminal 331 with a hole 332 for inserting a contact line or wire and further comprises two protrusions 333a and 333b arranged on opposite sides with respect to the terminal 331 and configured to provide the latching mechanism to fixate the second terminal 330, for example, to the first connection part 210 depicted in FIG. 4B.

This additional connection socket 200 of the module comprises the advantage of improving the security. For example, if for some reason the switch 120 does not shorten the solar module 100, a possibly high voltage is present at the terminals 101 and 102. Thus, by implementing the first part 210 at the terminal 101 and the second part 230 at the second terminal 102 (see FIG. 1), an additional safety mechanism is provided to ensure that no person can be in contact with the possibly high voltage generated during installation of the solar modules. Moreover, the sockets shown in FIG. 4B provide a solid mechanical fixation of the connection line 301 so that even mechanical stress cannot open the electric connection between the various solar modules.

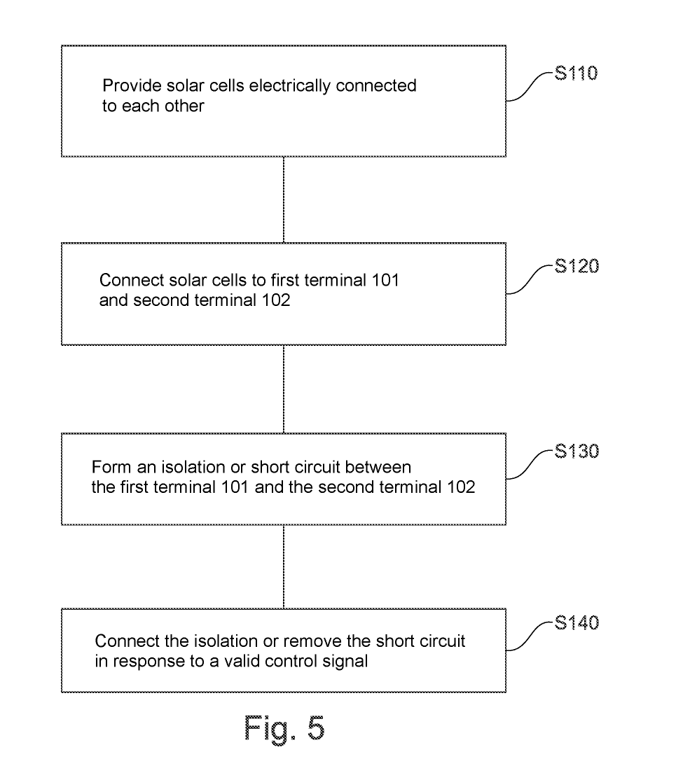

FIG. 5 shows a flow diagram for a method for producing a solar cell module according to an exemplary embodiment of the present invention. The method includes the following steps: Provision Silo of solar cells 110 which are electrically connected to one another, connection S120 of the solar cells 110 to a first terminal 101 and a second terminal 102, formation S130 of a short circuit (or isolation) between the first terminal 101 and the second terminal 102 (or of the solar cells) and opening S140 of the short circuit (or connection of the isolation) in response to the presence or receipt of a valid control signal. The short circuit/isolation is produced by the switch 120, as can be seen in FIG. 1, wherein the switch 120 is preset to form the short circuit/isolation and only removes the short circuit/isolation as a result of an activation (i.e. transmission of the valid control signal).

Exemplary embodiments of the present invention include the following advantages.

Firstly, it is possible to provide and use the solar cell modules 100 with cables, but without plugs, without the solar cell modules 100 representing a safety risk, wherein the high added value of an intelligent connecting socket is available. These solar cell modules 100 can therefore be used in all photovoltaic systems and solar farms. Considerable costs can be saved due to the omission of the plugs on the solar module 100. Faults at the plugs, as occur more frequently in systems from FIG. 6, are likewise excluded.

As the terminals 101, 102 are automatically short-circuited, according to exemplary embodiments, safety is not adversely affected in the absence of a control signal or on transmission of a false control signal. By a suitable choice of control signal, it can be ensured that no unintentional activation of the solar cell modules 100a, 100b, 100c can occur.

In addition, it is possible to quite selectively switch off the solar cell modules. This can be achieved, for example, in that the transmission of the control signal is interrupted (if, for example, continuous transmission is required for activation) or a different control signal (i.e. no activation signal) is transmitted. This enables fireman's switches, which allow the whole system to be quickly shut down, to be implemented. Furthermore, the string concerned can be automatically switched off as a result of unintentional isolation (someone mowing the grass or grazing animals), thus preventing the risk of an electric shock.

As the valid activation signal can be encrypted and the key can accordingly be kept secret, this likewise enables very efficient protection against theft. In particular, protection against theft is very efficient when the switch 120 is integrated into the solar cell module (e.g. as an integrated circuit) so that the switch 120 cannot be simply bridged or disconnected without damaging the solar cell module 100. In a similar manner, some or all solar cell modules 100 can be deactivated by remote shutdown. A power reduction or power optimization (in accordance with the requirements of the German Renewable Energy Act EEG 2012 §6 Para 1 & 2) can be implemented by deactivating some solar cell modules.

Thanks to the integrated intelligence of the switch unit of each module, it is furthermore possible to record additional information such as voltage, current, temperature, serial number etc. and transmit it by cable or wireless, which enables extended monitoring.

The characteristics of the invention disclosed in the description, the claims and the figures can be material for the realization of the invention both individually and in any combination.

### LIST OF REFERENCES

100 (100a, 100b, 100c, 100d, . . . ) Solar cell module(s)

101 First terminal

102 Second terminal

120 Switch (in connecting socket)

125 Control terminal

140 Connecting socket

150 Inverter with control device

151 Inverter mains connection

200 connection socket

210, 220, 230 part of the connection socket

211, 231 terminals of the connection socket

212, 312 recess

232, 332 hole

213, 233, 313, 333 latching components

301 connection line

310, 330 line terminals

600(a,b,c,d, . . . ) Conventional solar cell modules

601, 602 At least one uninsulated terminal

604, 605 Y-connectors

603, 606 Leads

621, 622 Conventional plugs

640 Conventional connecting socket

650 Conventional inverter

651 Conventional mains connection

1. A solar cell module (100) comprising:
a first terminal (101) and a second terminal (102);
a plurality of solar cells (110) which can be electrically connected to one another between the first terminal (101) and the second terminal (102) in order to generate a voltage between the first terminal (101) and the second terminal (102) in normal operation; and
a switch (120) which electrically connects the first terminal (101) and the second terminal (102) to one another in a default setting or disconnects the plurality of solar cells (110) from the first or from the second terminal (101, 102) and can be controlled in such a way that, when a valid control signal is present, the first terminal (101) is electrically disconnected from the second terminal (102) or the plurality of solar cells (110) is connected to the first and the second terminal (101, 102).

2. The solar cell module (100) according to claim 1, wherein the first terminal (101) and/or the second terminal (102) are plugless.

3. The solar cell module (100) according to claim 1, further comprising a connection socket (200) with one or more components (210, 220, 230) attached on a rear side of the solar cell module (100) and being configured for providing latching contacts for connection lines (301) to connect multiple solar cell modules (100a, 100b, . . . ) with each other.

4. The solar cell module (100) according to claim 1, wherein the valid control signal has a predetermined voltage characteristic which differs from zero.

5. The solar cell module (100) according to claim 1, wherein the valid control signal is coded in the form of a predetermined pulse sequence.

6. The solar cell module (100) according to claim 1, wherein the valid control signal is present in the form of an encrypted signal and the switch (120) is designed to decrypt the encrypted signal and to electrically isolate the first terminal (101) from the second terminal (102) in response to a recognition of the valid control signal.

7. The solar cell module (100) according to claim 1, wherein the valid control signal is specifically for the solar cell module (100) or for a plurality of solar cell modules (100a, 100b, 100c) so that one or more solar cell modules (100a, 100b, 100c) can be selectively activated by transmitting the valid control signal.

8. The solar cell module (100) according to claim 1, wherein the switch (120) can be connected to a control device (150) by means of a photovoltaic cable or by wireless, wherein the control device (150) provides the valid control signal.

9. The solar cell module (100) according to claim 1, wherein the switch (120) has a network interface to a wireless network and the network interface is designed to receive the valid control signal via the wireless network.

10. The solar cell module (100) according to claim 1, wherein the switch (120) is further designed to retain a switching state as long as the valid control signal is present and, in the absence of the control signal, automatically connects or disconnects the first terminal (101) to/from the second terminal (102).

11. The solar cell module (100) according to claim 1, wherein the switch (120) is further designed to also retain a switching state in the absence of the valid control signal so that a single transmission of the valid control signal is sufficient to permanently open the switch between the first terminal (101) and the second terminal (102).

12. The solar cell module (100) according to claim 1, wherein the switch (120) is further designed to electrically connect the first terminal (101) to the second terminal (102) when a further control signal is present.

13. The solar cell module (100) according to claim 1, wherein the solar cell module (100) together with the switch (120) forms a monolithic unit.

14. The solar cell module (100) according to claim 1, wherein the first terminal (101) and the second terminal (102) are integrated in the switch (120) and are designed to electrically connect to and fix at least one connecting cable by inserting it.

15. The solar cell module (100) according to claim 14, wherein the first terminal (101) and the second terminal (102) have a push-in clamp connection which allows a connecting cable to be pushed in in one direction and blocks it in an opposing direction.

16. A method for producing a solar cell module (100) having the following steps:
providing (S110) solar cells (110) which are electrically connected to one another;
connecting (S120) the solar cells (110) to a first terminal (101) and a second terminal (102);
forming (S130) a short circuit between the first terminal (101) and the second terminal (102) or a disconnection of the plurality of solar cells (110) from the first or from the second terminal (101, 102); and
opening (S140) the short circuit or closing of the disconnection of the plurality of solar cells (110) from the first or from the second terminal (101, 102) in response to the presence of a valid control signal.
